(19) United States
(12) Patent Application Publication
(10) Pub. No.: US 2024/0391547 A1
(43) Pub. Date: Nov. 28, 2024

(54) MOUNTING DEVICE FOR A BICYCLE ACCESSORY, MOUNTING SYSTEM, AND METHOD OF MOUNTING

(71) Applicant: Invented Here B.V., Ulft (NL)

(72) Inventors: Roel Johannes Oda VAN HEUR, Ulft (NL); Marthijn Marinus Gerardus Henrikus VAN BALVEREN, Ulft (NL)

(21) Appl. No.: 18/688,103

(22) PCT Filed: Jul. 12, 2022
(86) PCT No.: PCT/NL2022/050405

§ 371 Date: Feb. 29, 2024

(30) Foreign Application Priority Data
Aug. 30, 2021 (NL) 2029080

(51) Int. Cl. B62J 7/08

(52) U.S. Cl. CPC B62J 7/08

(57) ABSTRACT

Mounting device for releasably mounting a bicycle accessory, for example a bag or a basket, to a bicycle rack which is provided with a mounting plug, the mounting device comprising: an attachment structure configured for attaching the mounting device to the bicycle accessory: a socket configured for receiving the mounting plug of the bicycle rack therein; and a locking mechanism for releasably locking the mounting plug in the socket when the mounting plug is received in the socket. One or more of such mounting devices may be comprised by a mounting system which further comprises the bicycle accessory, the bicycle rack, a guide rail, a securing pin, and/or a support device.

### FIELD

The invention relates to mounting of a bicycle accessory to a bicycle rack.

### BACKGROUND

Various methods are known for releasably mounting bicycle accessories such as bags and baskets to a bicycle rack. In some cases, a bicycle rack is provided with one or more, for example three, mounting plugs, sometimes called studs, which are intended for mounting a suitable bicycle accessory thereto. In some examples, the plugs extend substantially laterally from the bicycle rack so as to enable the bicycle accessory to be positioned on a side of the rack when mounted. An example thereof is disclosed in DE102011118867A1.

While mounting a bicycle accessory using such mounting plugs can provide advantages, it has been found that improvements are nevertheless desirable, in particular in terms of versatility and adjustability of the mounting.

### SUMMARY

An object of the present invention is to provide one or more improvements in the releasable mounting of a bicycle accessory to a bicycle rack which is provided with a mounting plug. An object is to provide improved versatility and/or adjustability regarding such mounting. An object is to provide such mounting in a relatively user friendly way and/or at relatively low cost. An object is to at least provide an alternative.

To that end, an aspect of the invention provides a mounting device for releasably mounting a bicycle accessory to a bicycle rack which is provided with a mounting plug. The mounting device comprises: an attachment structure configured for attaching the mounting device to the bicycle accessory; a socket configured for receiving the mounting plug of the bicycle rack therein; and a locking mechanism for releasably locking the mounting plug in the socket when the mounting plug is received in the socket.

Such a mounting device advantageously provides increased versatility and adjustability regarding mounting of a bicycle accessory to mounting plugs of a bicycle rack, in particular for bicycle accessories which do not have integrated means for mounting to such mounting plugs, or whose means for mounting are fixedly positioned and/or oriented during manufacturing.

For example, the mounting device can be attached to the bicycle accessory, e.g. by a user, in such a way so as to match one or more positions and/or orientations of mounting plugs of the bicycle rack to which the accessory is to be mounted, and/or in such as way so as to define or adjust a desired position and/or orientation of the mounted bicycle accessory with respect to the bicycle rack.

The attachment structure can be realized in various ways, as will be explained further herein. Attaching the mounting device to the bicycle accessory may comprise fixedly attaching the mounting device to the bicycle accessory. Preferably, the mounting device is adjustably and/or releasably attached to the bicycle accessory, so that a relatively high versatility and adjustability are maintained even after initial use. Meanwhile, the attaching is preferably such that the position and/or orientation of the mounting device with respect to the bicycle accessory is at least selectively stable, e.g. by releasable fastening, so as to provide a substantially stiff connection between the mounting device and the bicycle accessory during use.

The mounting device may be considered as comprising three subsequent sections, namely a front section which comprises an entrance opening of the socket, a middle section which comprises the locking mechanism, and a rear section which comprises the attachment structure. As explained further elsewhere herein, the entrance opening of the socket is preferably normally directed substantially horizontally, extending in a frontal outer face of the front section and surrounded, e.g. encircled, by the front section on all sides, thus corresponding to and enforcing a normally horizontal or lateral receiving direction of the plug into the socket. The locking mechanism may comprise a locking element biased towards the socket for locking the mounting plug when received in the socket. The locking element can thus be arranged between the entrance opening and the attachment structure, in particular at some distance from both the associated front and rear sides or faces of the mounting device. Each section can be provided as a separate component, which can be assembled together to form the mounting device. As such, three components may form the mounting device, and relatively easy manufacturing and assembly can be possible. The socket for receiving the mounting plug may thus extend over the front section and the middle section, and, in some examples even into the rear section. The mounting plug may, when received in the mounting device abut the rear section, or may extend partially into or through the rear section.

In the context of the present invention, a mounting plug can be regarded as a male structure which is suitable for mounting a bicycle accessory thereto. The mounting plug may for example have a pin shape, a stud shape, a mushroom shape, a hook shape, and/or another male shape.

Preferably, a mounting plug has a relatively small width and/or a relatively small length, so as to be relatively unobtrusive when no bicycle accessory is mounted thereto. For example, such width and thickness may be in the same order of magnitude as, e.g. be about the same as, a thickness of an associated frame section of the bicycle rack.

The socket may be configured, e.g. shaped and/or dimensioned, to closely match the mounting plug in order to minimize play therebetween when the plug is received in the socket, but this is not strictly necessary. Alternatively, such play may be acceptable or even desirable, e.g. to promote easy insertion and/or for dampening transmission of vibrations across the mounting, in which case the socket may be configured to permit and/or provide such play. It is also possible that such play is partially or fully mitigated otherwise than by a close fit between plug and socket, for example by a separate stabilizing means which may be provided at the mounting device, at the mounting plug, and/or elsewhere.

Preferably, the socket is shaped and/or restricted so as to limit insertion of the mounting plug therein to an insertion in a predefined receiving direction. Said receiving direction may correspond to one or more of: a movement towards each other of the bicycle accessory and the bicycle rack; a direction substantially normal to and/or towards a side, in particular a back side, of the bicycle accessory on which side the mounting device is positioned; a direction substantially normal to and/or away from a side of the bicycle rack on which side the mounting plug is positioned; and a main direction in which the mounting plug extends from the bicycle rack. It shall be appreciated that in the present context, the receiving direction may thus correspond to a lateral direction with respect to the bicycle rack so as to be substantially horizontal during normal use of the bicycle.

In other words, the socket and/or an entrance opening thereof may be configured to inhibit insertion of the mounting plug into the socket in a direction parallel to a side, e.g. back side, of the bicycle accessory, and/or parallel to a side, e.g. lateral side, of the bicycle rack. Thereto, as alluded to above, shapes and/or sizes of the mounting plug and the socket may mutually match, e.g. both being substantially cylindrical with main axes of the cylinders corresponding to a receiving direction which is lateral with respect to the bicycle rack and thus normally substantially horizontal. It shall be appreciated that alternatives to a cylinder shape are possible while otherwise maintaining the same effect, e.g. instead of a circular cross sectional profile a polygonal profile could be applied.

Thus, during use, an entrance opening of the socket preferably faces away from the bicycle accessory, in particular from a back side thereof. For example, such an entrance opening may thus be located, in particular extend only, in a front side of the mounting device, which front side faces away from the bicycle accessory during use. A body or housing of the 10 mounting device may thus close off the socket including the entrance opening on all sides except such a front side. In particular, the socket including the entrance opening may thus be substantially fully surrounded by such a body or housing, so that the body or housing can enclose a mounting plug received in the socket, apart from generally allowing movement of the mounting plug through the entrance opening of the socket, in particular only along a lateral or horizontal receiving direction.

Such a mounting device, in particular with such a socket, in particular in combination with one or more of such mounting plugs, advantageously enables easy and reliable mounting of a bicycle accessory to a bicycle rack using a substantially sideways approach of the bicycle accessory to the rack. Thus, even when an area at a top side of and/or above the rack is blocked, e.g. by luggage or another accessory positioned there, the bicycle accessory can be mounted conveniently, in particular without first having to remove whatever may be blocking a substantially downwards approach of the accessory towards the rack.

The socket is preferably provided with a tapered guiding structure, in particular at an entrance opening of the socket, for guiding, in particular centering, the mounting plug with respect to the socket when the mounting plug enters the socket. For example, the entrance opening may have a tapered annular shape along a circumference thereof, tapering from a wider outer end to a more narrow inner end. Such a guiding structure makes it easier for a user to align the mounting plug with the socket upon mounting the bicycle accessory to the bicycle rack. Thus, when the socket is substantially cylindrical, e.g. to match a cylindrical shape of the mounting plug, the entrance opening may be substantially circular with a circular annular tapering extending from an outer end with a diameter somewhat larger than a diameter of the mounting plug towards a smaller diameter more closely matching the general diameter of the mounting plug. Meanwhile, also the mounting plug may have tapered guiding structure at its distal end, with a diameter at the utmost distal end being somewhat smaller than the general diameter of the mounting plug and/or the socket.

Also the locking mechanism can be realized in various ways, as will be explained further herein.

Optionally, the locking mechanism comprises a locking element which is movable between a locking position and a releasing position, wherein in the locking position the locking element extends into the socket, wherein in the releasing position the locking element extends less or not into the socket.

Such a locking element can provide a reliable locking mechanism which is easy to use.

The locking element may be or comprise one or more of: a locking cam, a locking bolt, a locking hook, a locking lip, a locking bar, a locking arm, a locking prong and a locking ridge.

Optionally, in the locking position, when the mounting plug is received in the socket, the locking element extends into engagement with the mounting plug, in particular with a locking recess of the mounting plug.

Such a locking recess may for example be in the form of a circumferential groove in the mounting plug. The locking recess preferably comprises an abutment face which faces outward from the socket during use and which can thus prevent the plug from moving out of the socket by abutting against the locking element in its locking position.

Alternatively or additionally to engagement with such a locking recess, the locking element, at least the locking mechanism, may engage the mounting plug by engagement with an optional locking protrusion of the mounting plug, and/or by clamping, and/or by magnetic engagement. Such a locking protrusion may comprise an abutment face similar to the abutment face of the locking recess described above.

Optionally, the locking element is biased towards the locking position. To that end, the locking element is preferably provided with a biasing means, for example a biasing spring.

In this way, advantageously, an inserted mounting plug normally remains inserted, i.e. unless a deliberate user action causes the locking element to move to its releasing position, against the biasing.

Optionally, the locking mechanism comprises an operating element coupled to the locking element and configured for moving the locking element between the locking position and the releasing position from outside the socket.

Such an operating element may for example be formed at a second end of the locking element opposite a first end thereof which is configured to extend into the socket in the locking position. The operating element may extend outside a housing of the mounting device in which housing the socket may be formed, for example extending on a side of said housing, so as to be operable by a user.

Optionally, the locking mechanism comprises at least one securing element coupled to the locking element and configured for selectively securing the locking element in the locking position.

Advantageously, a mounted bicycle accessory may thereby be secured to the bicycle rack, i.e. so that release of the accessory from the rack is made dependent on some authorization such as by a key or a code. In this way, theft of the bicycle accessory from the bicycle rack can be prevented, at least be made more difficult.

Such a securing element may for example comprise an eye through which a securing pin can be extended so as to inhibit the locking element from reaching the releasing position. Such a securing pin may form part of, and/or be configured to cooperate with, a securing mechanism, for example a padlock.

Alternatively or additionally, the at least one securing element of the locking mechanism may itself form part of a securing mechanism, e.g. a key-based or code-based securing mechanism, which may for example be partly or fully integrated in the mounting device.

The aforementioned attachment structure of the mounting device optionally comprises a through hole which, at one end thereof, opens towards the bicycle accessory during use, and which is configured for receiving a fastening means therethrough so as to allow the received fastening means to be fastened to the bicycle accessory for thereby attaching the mounting device to the bicycle accessory.

A relatively simple yet effective and versatile attachment structure can thus be provided. Various fastening means can be used, for example a threaded bolt or a screw.

Optionally, the through hole opens into the socket at another end thereof.

In this way, the fastening means can be inserted and fastened via the socket, which normally does not contain a mounting plug at the time when the mounting device is being attached to the bicycle accessory. A central axis of the fastening means can thus coincide with a central axis of the socket, so that a particularly stable connection can be provided when the bicycle accessory is mounted to the rack. The through hole may be beveled or tapered, widening towards the end which opens into the socket, so as to stably and centrally receive an optional beveled or tapered head of the fastening means.

Optionally, the attachment structure comprises at least one slot which is configured for slideably receiving a guide rail therein, which guide rail is attachable to the bicycle accessory so as to allow attachment of the mounting device to the bicycle accessory via the guide rail.

In this way, the mounting device can conveniently be adjusted along the guide rail to adjust its position and/or orientation with respect to the bicycle accessory. Thus, a large number of possible mounting device positions can be provided, and a user can easily and finely readjust the mounted position of the bicycle accessory with respect to the rack as desired.

Optionally, the at least one slot is provided along an outer face of the mounting device, which outer face faces away from an entrance of the socket.

Thus, the mounting device can advantageously be adjusted transversely to a receiving direction of the mounting plug defined by the socket.

The guide rail is preferably configured to be attached to the bicycle accessory, for example via one or more through holes and/or other attachment structures in the guide rail. The guide rail may comprise an entry section which is configured to introduce the mounting device to the guide rail, in particular to engage the at least one slot with a guiding structure of the guide rail. The entry section may for example be arranged centrally along the guide rail. To couple the mounting device to the guide rail, the mounting device may first be positioned at the entry section, whereafter the mounting device may be slid along the guide rail so as to cause engagement between a guiding structure of the guide rail and the at least one slot of the mounting device. Once the mounting device reaches a desired position along the guide rail, it may be fastened in position e.g. by a fastening means which extends through the through hole of the mounting device and e.g. engages a counter fastening means, for example in the form of a threaded nut which is positionable on a reverse side of the guide rail with respect to the mounting device. If and when desired, a mounting device which is thus coupled to the guide rail may subsequently be removed from the guide rail essentially by reversing the steps described above.

Preferably, the locking mechanism is spaced away from an entrance opening of the socket, which entrance opening may extend in, in particular be confined to, a front side of the mounting device, which front side faces away from the bicycle accessory and/or towards the bicycle rack during use. Thus, the locking element may be configured to move between the locking position and the releasing position at a distance from said entrance opening, for example substantially parallel to the front side of the mounting device.

Preferably, the locking mechanism is spaced away from the attachment structure, which attachment structure may be arranged at a rear side of the mounting device, which rear side faces towards the bicycle accessory and/or away from the bicycle rack during use. Thus, the locking element may be configured to move between the locking position and the releasing position at a distance from said attachment structure, for example substantially parallel to the rear side of the mounting device.

Thus, the mounting device may be considered as comprising three main sections which may be distributed along a main direction in which the socket extends. The three sections include: a front section in which an entrance opening of the socket is formed; a middle section in which the locking mechanism, at least the locking element, is arranged; and a rear section in which the attachment structure is formed.

A particularly robust mounting device can thereby be provided. Nevertheless, it will be appreciated that alternative configurations of the mounting device are possible, wherein for example some or all of the aforementioned structures or functions overlap along the main direction of the socket.

The mounting device may be configured to dampen transmission of vibrations and/or shocks between the bicycle rack and the bicycle accessory. To that end, the mounting device may be comprise a damper and/or a damping material, which during use may be arranged between the mounting device and the mounting plug, between the mounting device and the bicycle accessory, and/or between portions of the mounting device.

A further aspect provides a mounting system comprising at least one mounting device as described herein. The mounting system further comprises at least one, preferably some, more preferably each, of: the bicycle accessory, wherein the mounting device is attached, at least attachable, to the bicycle accessory via the attachment structure; the bicycle rack which is provided with the mounting plug; another bicycle part which is provided with a mounting plug; the securing pin; the guide rail; and a support device.

The optional other bicycle part may for example be or comprise one or more of: a bicycle seat, a bicycle frame part, and a bicycle handlebar. In case such a bicycle part is provided with one or more mounting plugs, the mounting device may additionally or alternatively be used for mounting a bicycle accessory to such a bicycle part. As with mounting to a bicycle rack, the mounting device is preferably first attached to the bicycle accessory, whereafter the mounting plug can be received and releasably locked in the socket for releasably mounting the bicycle accessory to the bicycle part. In a further elaboration, the bicycle accessory may be provided with at least one mounting device as described herein and at least one support device or guiding device, wherein in use the bicycle accessory may be mounted by first engaging said support device or guiding device with a first mounting plug and subsequently engaging the mounting device with a second mounting plug, in particular so that the bicycle accessory is thereby mounted to at least two mounting plugs so as to inhibit rotation about an axis corresponding to either mounting plug. Such a support device or guiding device may be configured to allow some level of pivoting and/or shifting by the bicycle accessory so as to facilitate alignment of the mounting device with the second mounting plug while the support device or guiding device remains engaged with the first mounting plug. The support device or guiding device may thereto be provided with a tapered shape, e.g. a V-shape, in which the first mounting plug can be movably received, in particular in a transversal direction with respect to a main axis of said mounting plug, in particular while inhibiting release of the support device or guiding device from the first mounting plug in a direction corresponding to a main axis of said mounting plug.

Thus, mounting plugs may be used to advantage in various ways for mounting one or more various bicycle accessories to a bicycle. As one further example thereof, a so-called double bicycle bag (comprising two interconnected bag compartments to be arranged on either side of a bicycle rack) may be at least partly supported on respective mounting plugs which extend from either side of a bicycle rack, for example using a respective support device as described herein, or a different support device, on each side. Meanwhile a interconnecting top part of the double bicycle bag may be connected to a top side of the bicycle rack, for example using straps and/or a different connecting mechanism. In that case, either one or both or none of the two compartments of the double bag may optionally be provided with one or more mounting devices as described herein.

The optional support device comprises a respective attachment structure configured for attaching the support device to the bicycle accessory independently from the at least one mounting device and at least one support structure for pivotably supporting the support device on a further mounting plug of the bicycle rack.

Preferably, the support device, in particular its support structure, is configured to engage at least part of an optional locking recess of the further mounting plug, in particular so as to prevent that the support device and the mounting plug move away from each other when the support device is supported on the further mounting plug and the at least one mounting device has received a respective at least one mounting plug. To that end, the support device may comprise a hook structure which is configured to extend into the locking recess when the support device is supported on the further mounting plug.

As a possible alternative to the support device or the support structure, a connection and/or stabilization between the bicycle accessory and the rack may be provided by other means, in particular at a distance from the one or more mounting devices. For example, one or more hook-and-loop strips or the-like may be used to releasably and/or adjustably connect the bicycle accessory to the rack, for example at a distance below the one or more mounting devices. As a further possible alternative, the bicycle accessory may be mounted to the rack by connections between mounting devices and mounting plugs only.

Optionally, the number of mounting devices of the at least one mounting device is at least two. In that case the number of mounting plugs is preferably also at least two, for example two or three. Nevertheless it shall be understood that the number of mounting plugs need not correspond to the number of mounting devices.

As one example, two mounting devices may be adjustably coupled to a same guide rail, in particular mutually spaced apart along the guide rail. A particularly stable mounting of the bicycle accessory can thus be provided, in particular in combination with the optional support device which may be positioned at a distance from the two mounting devices to provide a particularly stable three-point mounting.

Optionally, the at least two mounting devices are attached to the bicycle accessory at respective positions which correspond to positions of respective mounting plugs of the bicycle rack, in particular with a mutual distance which corresponds to a distance between mounting plugs.

As alluded to above, such positions can be realized by adjustment along the optional guide rail, for example. Alternatively or additionally, the position and/or orientation of the guide rail itself with respect to the bicycle accessory may be adjusted, for example by reattaching the guide rail.

Optionally, the mounting system further comprises a common handle which is coupled, at least couplable, to respective operating elements of the mounting devices so as to enable single-handed simultaneous movement of the locking elements of the mounting devices to their releasing positions by movement, in particular lifting, of the common handle.

Advantageously, such a common handle may be substantially in the form of, and/or may be used as, a general carrying handle for the bicycle accessory, so that a user can essentially release a mounted bicycle accessory form the rack by lifting and/or tilting the bicycle accessory by said common handle.

Optionally, the bicycle accessory comprises a plurality of respective attachment structures, for example threaded holes, configured for attachment of at least one mounting device and/or a support device and/or a guide rail thereto, in particular selectively at one or more of a plurality of predefined positions and/or selectively in one or more of a plurality of predefined orientations with respect to the bicycle accessory, so as to match two or more positions of mounting plugs of the bicycle rack and/or so as to enable a definition of a mounted position of the bicycle accessory with respect to the bicycle rack.

It shall be understood that the at least one mounting device may be attached to such an attachment structure of the bicycle accessory with or without a guide rail therebetween. The use of a guide rail is however preferred to enable easy adjustment, in particular without requiring a large number of attachment structures in the bicycle accessory.

Optionally, the attachment structures of the bicycle accessory are arranged in a reinforcement structure of the bicycle accessory. Preferably, the reinforcement structure is or can be fixedly or releasably arranged on an outer side of the bicycle accessory, for example on an outer back side thereof, in particular so as to be accessible and/or visible from outside the bicycle accessory.

For example, the reinforcement structure may be or comprise a reinforcement plate, one or more ribs, and/or one or more frames. The reinforcement structure preferably imposes a relatively stiff connection between the attachment structures of the bicycle accessory so as to enable said attachment structures to have relatively stable positions with respect to each other, thus aiding in easy and stable mounting of the bicycle accessory to the rack. The reinforcement structure may for example be T-shaped or I-shaped or H-shaped. The reinforcement structure provides stiffness to the bicycle accessory and provides for load distribution from the mounting devices connected thereto.

Optionally, the bicycle accessory is or comprises a container, for example a bag or a basket, for transporting goods on the bicycle rack. Alternatively or additionally, the bicycle accessory may be or comprise one or more of: a light source; a reflector; a decoration; a bicycle pump; a battery; a repair kit; a tool; a spare part; a bicycle lock; a solar panel; a safety accessory such as a warning triangle, an airbag, a bumper, a fender, or anti-falling equipment; and a water container such as a water bottle or water tank.

Such a container can advantageously continue to be functional, in particular hold items therein, while it is mounted to and released from the rack using the mounting system. Advantageously, the bicycle accessory is provided with at least one mounting device, that is associated with a mounting plug on the bicycle rack. The mounting device can couple with its associated mounting plug.

A further aspect provides a method of releasably mounting a bicycle accessory to a bicycle rack which is provided with a mounting plug. The method comprises: attaching at least one mounting device as described herein to the bicycle accessory using the attachment structure; and causing the mounting plug to be received in the socket, wherein the mounting plug is releasably locked in the socket using the locking mechanism.

Such a method provides above mentioned advantages. As alluded to above, preferably at least two mounting plugs are received and releasably locked in respective sockets of corresponding at least two mounting devices.

Optionally, the method further comprises, prior to causing the mounting plug to be received in the socket: attaching to the bicycle accessory a support device which comprises a respective attachment structure configured for attaching the support device to the bicycle accessory independently from the at least one mounting device and at least one support structure for pivotably supporting the support device on a further mounting plug of the bicycle rack; and pivotably supporting the attached support device, and thereby the bicycle accessory, on the further mounting plug of the bicycle rack.

Preferably, causing the mounting plug to be received in the socket then comprises pivoting the bicycle accessory with respect to the bicycle rack, in particular about a pivoting axis associated with the pivotable supporting.

If and when desired, a bicycle accessory may be secured to the rack in its mounted state, in particular by inserting the securing pin through eyes of securing elements of the mounting devices and by subsequently securing the securing pin, for example by connecting a padlock to an end of the securing pin.

A particularly versatile and easy to use method is thus provided for releasably mounting a bicycle accessory, such as a basket or a bag, to a bicycle rack which is provided with one or more mounting plugs.

### DETAILED DESCRIPTION

In the following, the invention will be explained further using exemplary embodiments and drawings. The drawings are schematic and merely show examples. In the drawings, corresponding elements have been provided with corresponding reference signs. In the drawings,

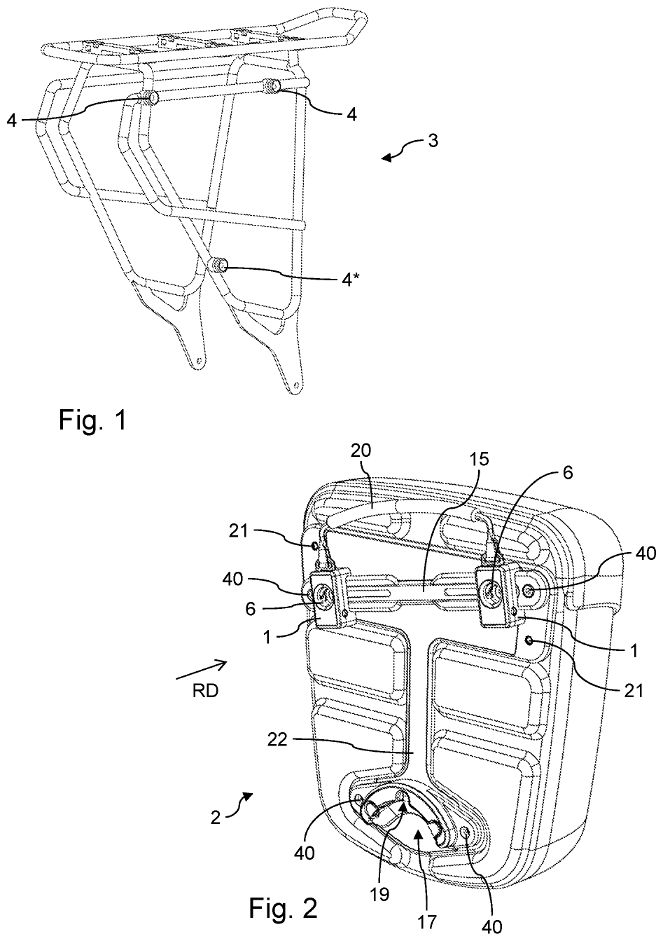

FIG. 1 shows a perspective view of an exemplary bicycle rack which is provided with mounting plugs;

FIG. 2 shows a perspective view of an exemplary assembly which includes an exemplary bicycle accessory and two exemplary mounting devices;

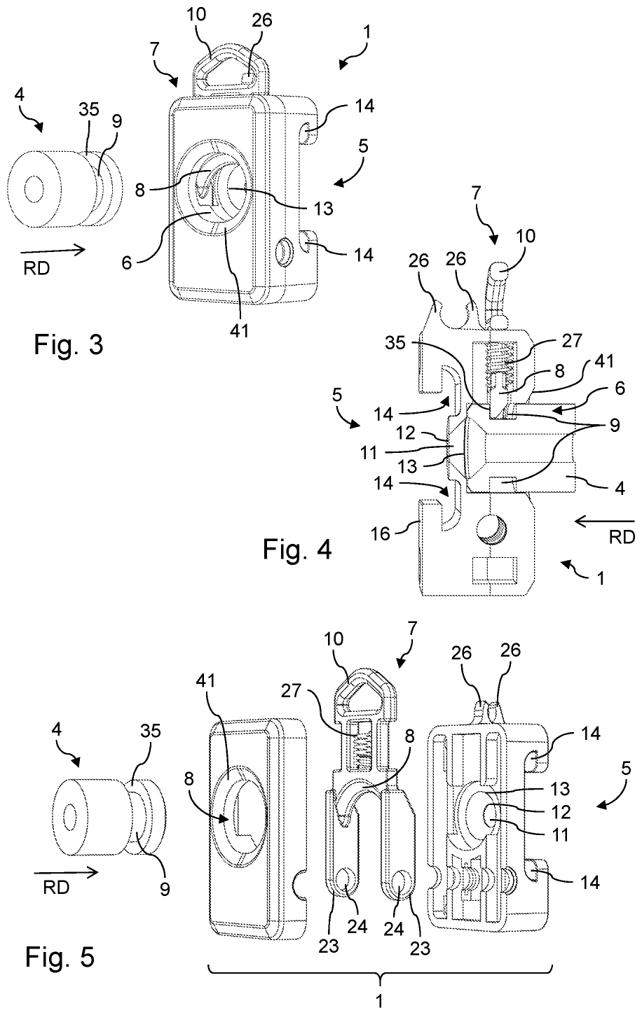

FIG. 3 shows a perspective view of an exemplary mounting device and an exemplary mounting plug;

FIG. 4 shows a cross sectional side view of the mounting device and mounting plug of FIG. 3, wherein the mounting plug is locked in the socket of the mounting device;

FIG. 5 shows an exploded perspective view corresponding to FIG. 3;

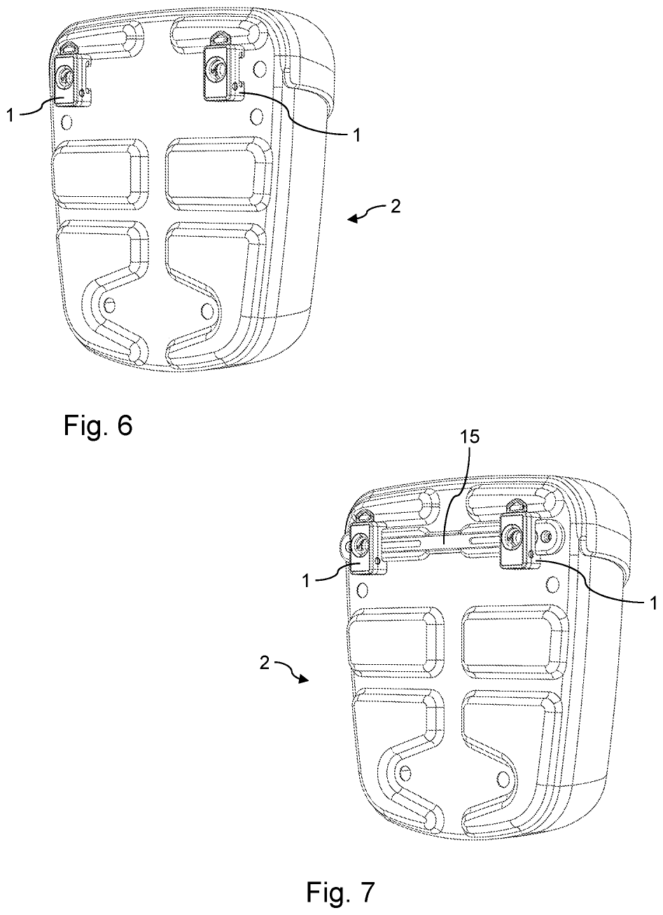

FIGS. 6 and 7 each show a perspective view of a respective further exemplary assembly which includes an exemplary bicycle accessory and two exemplary mounting devices;

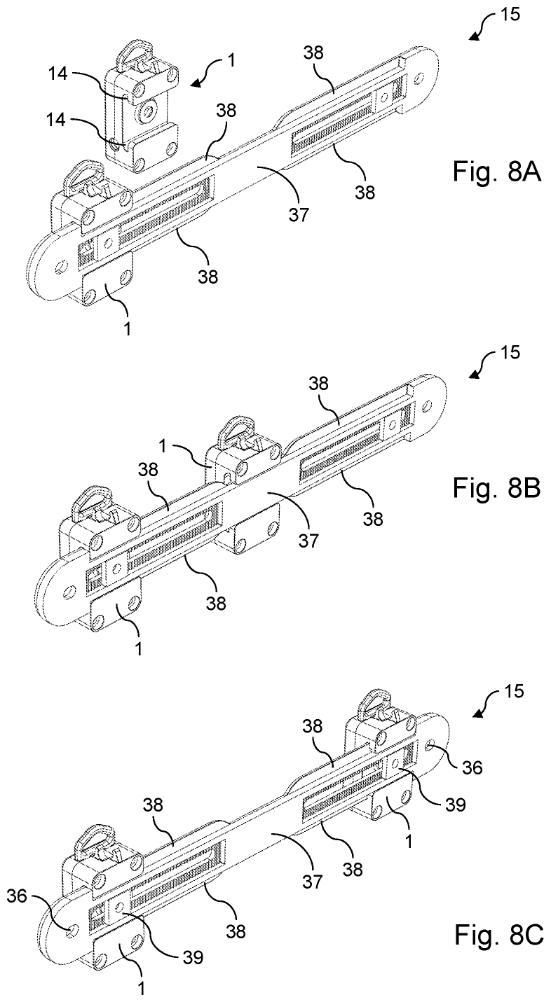

FIGS. 8A, 8B and 8C show perspective views of an exemplary guide rail with two exemplary mounting devices, wherein one of the mounting devices is in a different position in each of FIGS. 8A, 8B and 8C;

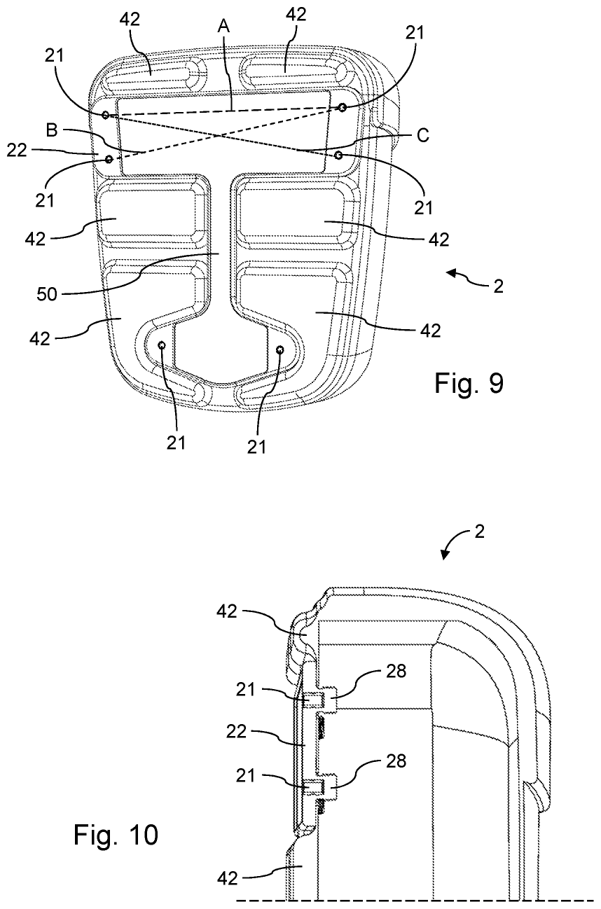

FIG. 9 shows a perspective view of an exemplary bicycle accessory including an exemplary reinforcement structure;

FIG. 10 show a cross sectional side view of a top portion of the bicycle accessory of FIG. 9;

FIG. 11 shows a perspective view of the reinforcement structure of FIGS. 9 and 10 form a reverse side compared to FIG. 9;

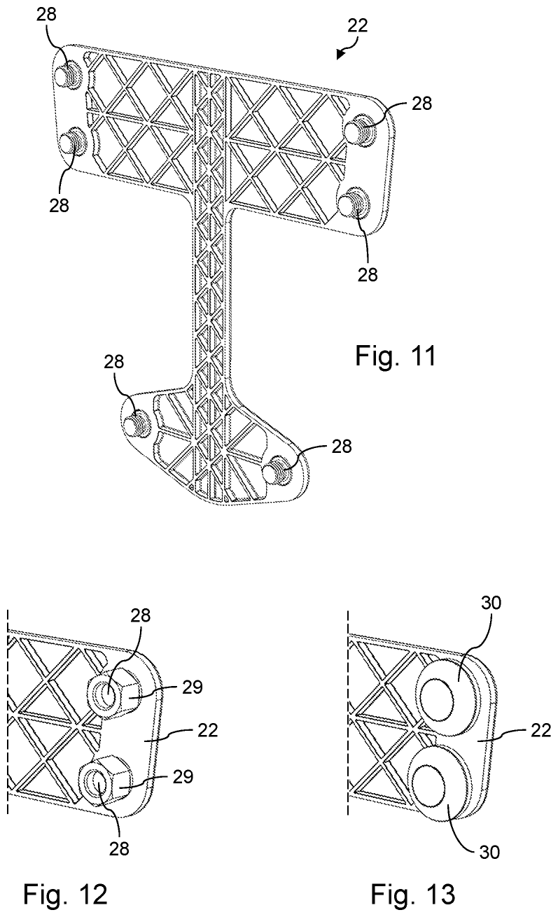

FIGS. 12 and 13 each show a perspective view of a portion of the reinforcement structure of FIG. 11, respectively with fastening nuts and with caps;

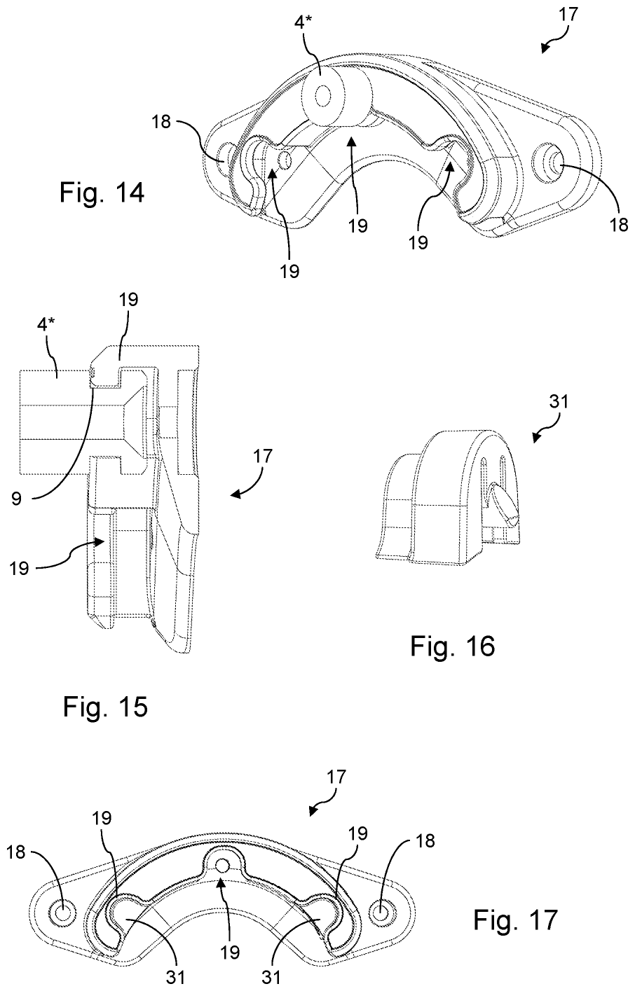

FIG. 14 shows a perspective view of an exemplary support device with an exemplary further mounting plug;

FIG. 15 shows a cross sectional side view of the support device with further mounting plug of FIG. 14;

FIG. 16 shows a perspective view of an exemplary closing element for the support device of FIGS. 14 and 15;

FIG. 17 shows a front view of the support device of FIGS. 14 and 15 provided with two closing elements as shown in FIG. 16;

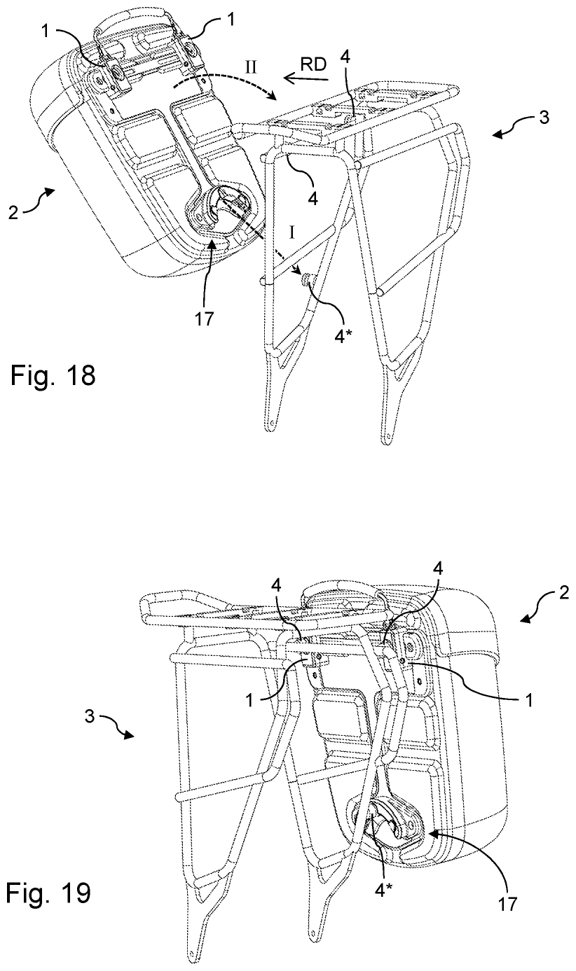

FIG. 18 shows a perspective view of an exemplary mounting system, wherein the bicycle accessory is not yet mounted to the bicycle rack;

FIG. 19 shows a perspective view of the mounting system of FIG. 18, wherein the bicycle accessory is mounted to the bicycle rack;

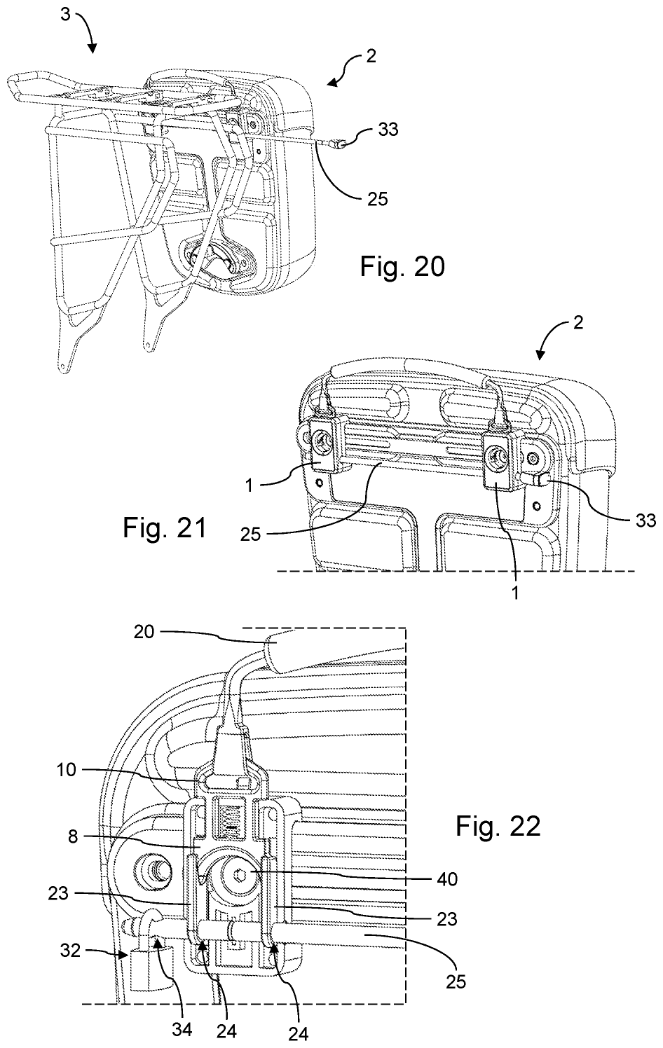

FIG. 20 shows a perspective view similar to FIG. 19, wherein additionally a securing pin is shown;

FIG. 21 shows a perspective view of a top portion of a bicycle accessory with mounting devices of FIG. 20, wherein the securing pin is in a securing position;

FIG. 22 shows a partly opened perspective view of a top left portion of the situation of FIG. 21, wherein additionally a padlock is arranged on the securing pin;

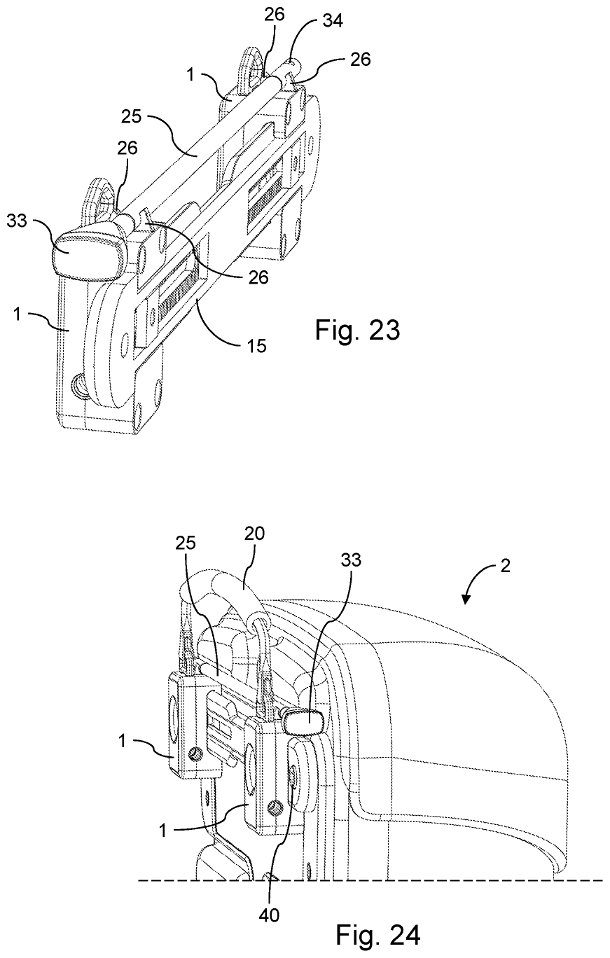

FIGS. 23 and 24 show perspective views of the guide rail with two mounting devices of FIGS. 20 to 22, wherein the securing pin is in a storage position, being received by pin holding elements of the mounting devices;

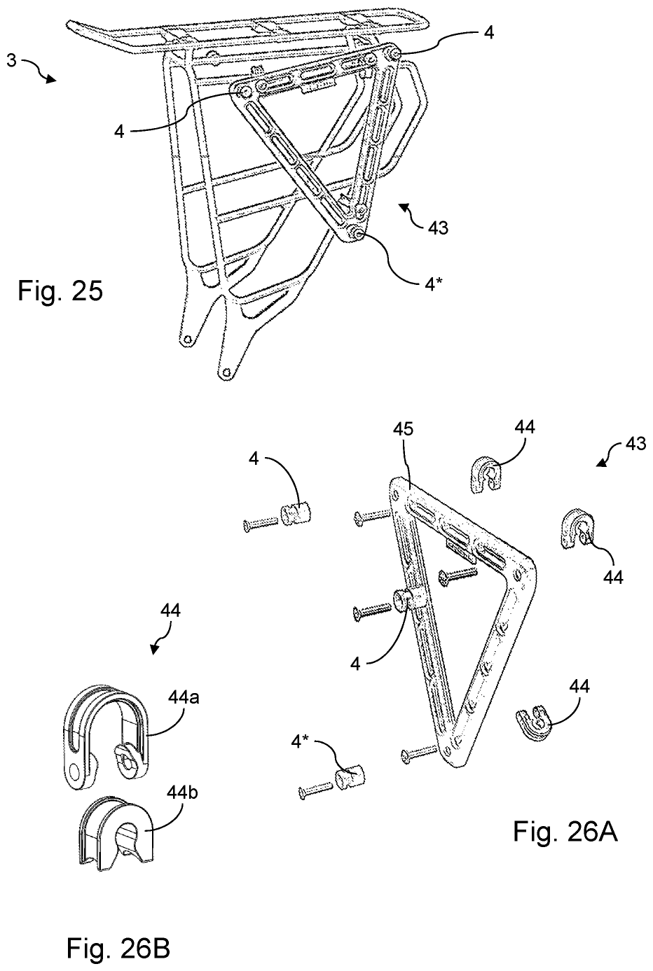

FIG. 25 shows a perspective view of a bicycle rack with an intermediate connecting device;

FIG. 26A shows an exploded perspective view of the intermediate connecting device of FIG. 25;

FIG. 26B shows an exploded perspective view of a connecting clamp for the intermediate connecting device of FIGS. 25 and 26A;

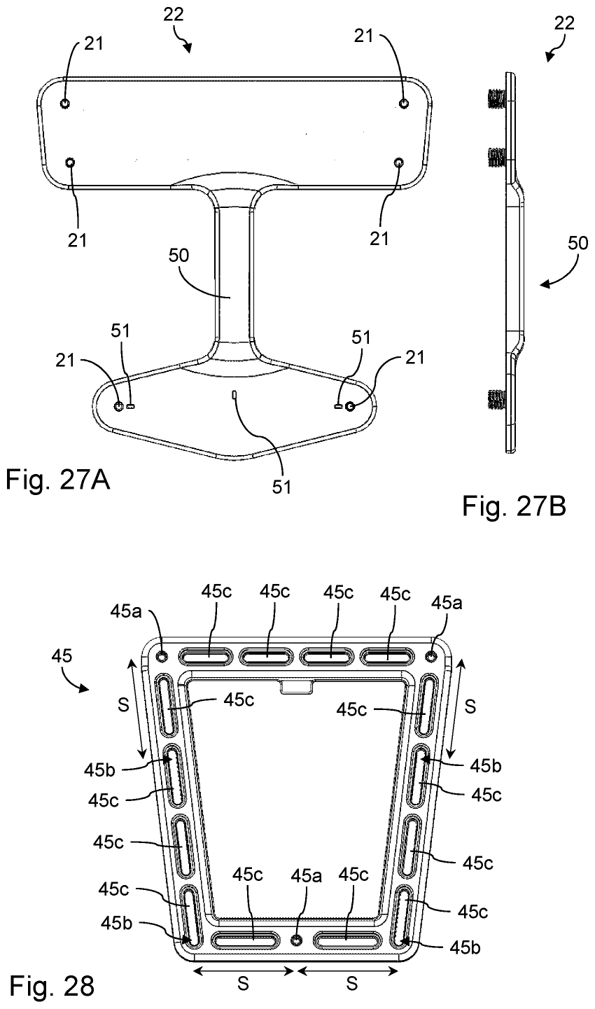

FIGS. 27A and 27B show a front view and a side view, respectively, of a variation of a reinforcement structure;

FIG. 28 shows a variation of a frame of an intermediate connecting device;

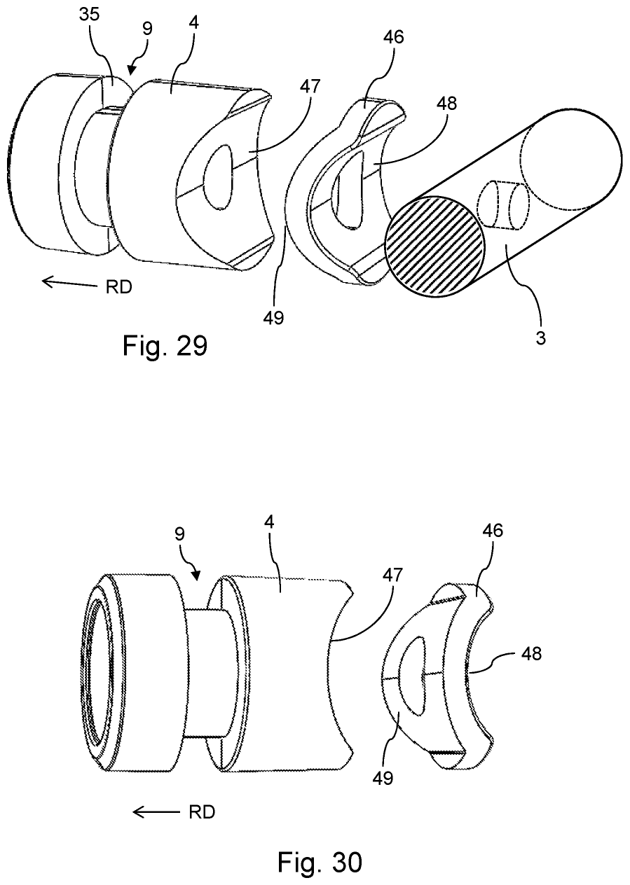

FIG. 29 shows an exploded perspective view of a mounting plug with an adaptor element and a section of a bicycle rack; and

FIG. 30 shows a further exploded perspective view of the mounting plug and adaptor element of FIG. 29.

FIG. 1 shows an exemplary bicycle rack 3 which is provided with three mounting plugs 4, 4* on a side of the bicycle rack 3, here designated as two mounting plugs 4 and one further mounting plug 4* arranged below the two mounting plugs 4. In this example, the mounting plugs 4, 4* each have essentially the same shape and size, but this is not strictly necessary. Also, it shall be understood that still further mounting plugs may be provided on the same bicycle rack. For example, three corresponding mounting plugs may be provided on an opposite side of the bicycle rack. In the shown example of FIG. 1, the mounting plugs 4, 4* are fixedly and directly connected to a frame of the bicycle rack 3, e.g. by a threaded bolt or screw or other fastening means extending through a central bore of the plug 4 and engaging e.g. a pre-arranged engagement structure such as a threaded hole in the bicycle rack 3. As illustrated in FIGS. 29 and 30, for close fitting onto a convex part, e.g. a tube, of the bicycle rack 3, the mounting plug 4 may be provided with a concave end 47, e.g. dimensioned in accordance with a relatively large, e.g. largest, expected tube diameter of the bicycle rack 3. Then, to accommodate a variety of such tube diameters, as shown in FIGS. 29 and 30, an adaptor element 46 may be provided between the concave end 47 and the bicycle rack 3, the adaptor element 46 having a convex end 49 facing the concave end 47 of the plug 4 and a respective concave end 48 corresponding to a smaller, e.g. smallest, expected tube diameter of the bicycle rack 3. If a particularly large range of tube diameters is to be accommodated, multiple such adaptor elements could be stacked, e.g. in order from larger to smaller diameter with each next adaptor element fitting to the previous adaptor element. It shall be appreciated that some embodiments may be free from such adaptor elements and/or concave ends, and that an end of the mounting plug facing the bicycle rack could for example be flat. Also, in the present context, the expression that mounting plugs may be mounted to the bicycle rack ‘directly’ does not exclude the presence of such adaptor elements, as will be appreciated from the following description of non-direct mounting options.

With reference to FIG. 25, alternatively to direct mounting of the mounting plugs, such mounting plugs may for example be connected to and/or form part of an intermediate connecting structure or connecting device 43 which in turn is connected, e.g. releasably and/or adjustably connected, to the bicycle rack 3. An exploded view of such an intermediate connecting device 43 is shown in FIG. 26A. The connecting device 43 can be seen to comprise a frame 45 to one side of which mounting plugs 4, 4* are fastened using threaded bolts. On an opposite side of the frame 45, connecting clamps 44, which can clamp onto and thereby robustly connect to sections of the rack 3, are fastened, also using threaded bolts. While FIGS. 25 and 26A show the frame 45 as having a triangular shape, other shapes, for example a rectangular shape and/or a trapezoid shape, are possible and can provide additional versatility. FIG. 28 shows a variation in which the frame 45 has such a trapezoid shape, in particular with a wider lower end compared to the triangular shape of FIGS. 25 and 26A. Meanwhile, the mounting plugs 4, 4* and connecting loops 44 or other connecting means are preferably connectable at various positions along the frame 45, as can be seen in FIGS. 25 and 26A, for example via slits 45c provided along the frame 45, as indicated in FIG. 28. As shown in FIG. 26B, such a connecting loop or clamp 44 may comprise an outer part 44a and an inner part 44b fitting into the outer part 44a, wherein the inner part 44b may be exchangeable so as to fit a size, e.g. diameter, of a part of the bicycle rack 3 to which it is to be mounted. Further, with reference to FIG. 28, mounting plugs may be mounted to such a frame 45 at various positions, e.g. one or more primary mounting plug positions 45a (corresponding to the arrangement in FIGS. 25 and 26A), and/or one or more secondary mounting plug positions 45b which may be along the aforementioned slits 45b. In the example of FIG. 28, the indicated secondary positions 45b are each at a standard distance S, here 64.5 mm, from a closest one of the primary positions 45a, so as to correspond with such a standard distance as typically used for pre-arranged general accessory connecting positions in a bicycle frame. Thus, one or more of the slits 45c may be arranged and/or dimensioned so as to provide such secondary mounting plug positions 45b at such a standard distance S from a primary mounting plug position 45a and/or at such a standard distance from each other. As a result, the connecting device 43, in particular the frame 45 e.g. as shown in FIG. 28, can be highly versatile in that it can accommodate a wide variety of racks and bicycle accessories, and moreover in that a mounted position and/or orientation of the accessory with respect to the rack can thereby be adjusted over a considerable range of possible positions and/or orientations.

FIG. 2 shows an assembly which includes a bicycle accessory 2, here a bag, and two mounting devices 1 which are configured for releasably mounting the bicycle accessory 2 to the bicycle rack 3. Here, both mounting devices 1 are configured as shown in FIGS. 3-5. Thus, each mounting device 1 comprises an attachment structure 5 configured for attaching the mounting device 1 to the bicycle accessory 2, which attaching can be either directly or indirectly. Here, the attachment structure 5 comprises a through hole 11 and two slots 14, as will be explained further herein.

The mounting device 1 comprises a socket 6 configured for receiving a mounting plug 4 of the bicycle rack 3 therein, in particular in a receiving direction RD. The mounting device 1 further comprises a locking mechanism 7 for releasably locking the mounting plug 4 in the socket 6 when the mounting plug 4 is received in the socket 6.

It shall be understood that the receiving direction RD here is defined as a relative direction in which the mounting plug 4 enters the socket 6 when the bicycle accessory 2 with the mounting devices 1 is moved towards the bicycle rack 3. In particular it shall be clear that the bicycle rack 3 with the mounting plugs 4 is normally stationary while the bicycle accessory 2 with the mounting devices 1 is moved to mount the accessory 2 to the rack 3. Thus, in practice, the mounting devices 1 may move towards and along the mounting plugs 4 in a direction substantially opposite to the indicated receiving direction RD. In the shown example, the indicated receiving direction RD corresponds to a main direction in which the mounting plugs 4 extend from the bicycle rack 3, which is here seen to be a lateral direction with respect to the bicycle rack 3 so as to be substantially horizontal during normal use of the bicycle. To inhibit insertion of the mounting plug 4 into the socket 6 otherwise than in such a lateral receiving direction RD, shapes and sizes of the mounting plug 4 and the socket 6 can be seen here to mutually match, in particular both being substantially cylindrical with main axes of the cylinders corresponding to a receiving direction RD which is lateral with respect to the bicycle rack 3 and thus normally substantially horizontal. Further enforcement of the lateral receiving direction RD is provided by the configuration of the entrance opening 41 of the socket 6, as explained below.

An entrance opening 41 of the socket 6 here extends in a front side or front face of the mounting device 1. The entrance opening 41 is here formed with a tapered circumferential shape, gradually becoming narrower in the receiving direction RD. The tapered shape provides a guiding structure to help center the mounting plug 4 in the socket 6 upon insertion of the plug 4, i.e. when the bicycle accessory 2 is mounted to the bicycle rack 3. Meanwhile, as a further guiding structure, the mounting plugs 4 have a tapering at their distal ends, see e.g. FIG. 4.

The locking mechanism 7 here comprises a locking element 8 which is movable between a locking position, which is shown in FIGS. 3 to 5, and a releasing position. In the locking position, the locking element 8 extends into the socket 6. In the releasing position, the locking element 8 does not extend into the socket 6. In the views of FIGS. 3 to 5, the locking element 8 moves upwardly when it moves from the shown locking position to the releasing position.

In FIGS. 4 and 5, it can be seen that the mounting device 1 in this example can be considered as comprising three subsequent sections along the receiving direction RD, namely a front section which comprises the entrance opening 41 of the socket 6, a middle section which comprises the locking mechanism 7, at least its locking element 8, and a rear section which comprises the attachment structure 5. The entrance opening 41 of the socket 6 is here extending in a frontal outer face of the front section and surrounded, in particular circumferentially surrounded, more in particular encircled, by the front section on all sides, thus corresponding to and enforcing a normally horizontal or lateral receiving direction RD of the plug 4 into the socket 6. The locking element 8 is arranged between the entrance opening 41 and the attachment structure 5, in particular at some distance from both the associated front and rear sides or faces of the mounting device 1. Each section can be provided as a separate component, which can be assembled together to form the mounting device. As such, relatively easy manufacturing and assembly can be possible. As can be seen e.g. in FIG. 3 or FIG. 5, the mounting plug 4, or a head thereof, is substantially cylindrical, and the socket 6 has a shape corresponding to the shape of the mounting plug 4 to optimally receive the mounting plug 4. Here, the mounting plug 4 is substantially cylindrical, and the entrance opening 41 of the socket is substantially circular shaped to optimally receive the mounting plug, while the socket 6 is correspondingly cylindrical shaped. Here, the head of the mounting plug 4, separated from a body of the mounting plug 4 with the locking recess 9, is cylindrical shaped. The head of the mounting plug 4 and/or the body of the mounting plug 4 may also have a different shape, e.g. triangular or rectangular. Then, preferably, the entrance opening 41 and the socket 6 are correspondingly shaped, e.g. triangular prismatic or rectangular prismatic respectively, to receive the mounting plug 4.

FIG. 4 shows that in the locking position, when the mounting plug 4 is received in the socket 6, the locking element 8 extends into engagement with the mounting plug 4, in particular with a locking recess 9 of the mounting plug 4. The locking recess 9 is here provided in the form of a circumferential groove in the mounting plug 4. The locking recess 9 comprises an abutment face 35 which faces outward from the socket 6 during use and which can thus prevent the plug 4 from moving out of the socket 6 by abutting against the locking element 8 in its locking position. The locking element 8 is biased towards the locking position by a biasing spring 27, so that the locking element 8 is normally in the locking position.

In this example, the locking mechanism 7 further comprises an operating element 10 coupled to the locking element 8 and configured for moving the locking element 8 between the locking position and the releasing position, in particular from the locking position to the releasing position, from outside the socket 6. Here the operating element 10 is formed at a second end of the locking element 8 opposite a first end thereof which is configured to extend into the socket 6 in the locking position. The operating element 10 here extends outside a housing of the mounting device 1 in which housing the socket 6 is formed, in particular extending from a top side of said housing.

Best seen in FIG. 5, the locking mechanism 7 here further comprises two securing elements 23 coupled to the locking element 8 and configured for selectively securing the locking element 8 in the locking position. The shown securing elements 23 each comprise a respective leg which is coupled to the locking element 8 and which comprises a respective eye 24 through which a securing pin 25 can be extended so as to inhibit the locking element 8 from reaching the releasing position. Such a securing pin 25 is shown in FIG. 22, wherein it can be seen that the locking element 8 is thus prevented from moving upwards in the mounting device 1 towards its releasing position. The securing pin 25 itself is here secured in place by a padlock 32.

Returning to FIGS. 3 to 5, the attachment structure 5 in this example comprises a through hole 11 which, at one end 12 thereof, opens towards the bicycle accessory 2 during use, and which is configured for receiving a fastening means, e.g. a fastening bolt or a screw, therethrough so as to allow the received fastening means to be fastened to the bicycle accessory 2, e.g. directly or indirectly, for thereby attaching the mounting device 1 to the bicycle accessory 2. The through hole 11 opens into the socket 6 at another end 13 thereof, so that a fastening means can be inserted in the through hole 11 when the socket 6 does not contain a plug 4. The through hole 11 is in this case beveled or tapered, becoming wider towards the end 13 which opens into the socket 6 so as to stably and centrally receive a head of a fastening bolt or screw, for example.

For clarity of the drawings, fastening means such as threaded bolts have in some instances not been shown and/or indicated in the drawings. Nevertheless, the skilled person having the benefit of the present disclosure will readily understand their appropriate application in the context of the present teachings.

The shown attachment structure 5 of the mounting device 1 further comprises two slots 14 which are configured for slideably receiving a guide rail 15 therein, as shown in FIGS. 8A-C. With reference to FIG. 4, the slots 14 are provided along an outer face 16 of the mounting device 1, which outer face 16 faces away from, in particular is directed opposite to, an entrance of the socket 6.

As shown in FIGS. 2 and 7, the guide rail 15 can be attached to the bicycle accessory 2 so as to allow attachment of the mounting device 1 to the bicycle accessory 2 via the guide rail 15. To that end, as indicated in FIG. 8C, two through holes are provided in the guide rail 15 as respective attachment structures 36 through which e.g. threaded fastening bolts 40 can be received as shown in FIG. 2.

Returning to FIGS. 8A-C, the exemplary guide rail 15 comprises a central entry section 37 which is configured to introduce the mounting device 1 to the guide rail 15, in particular to engage the slots 14 with guiding structures 38 of the guide rail 15. To couple the mounting device 1 to the guide rail 15, the mounting device 1 may first be moved towards and positioned at the entry section 37, thus from the position in FIG. 8A to the position in FIG. 8B. Thereafter the mounting device 1 may be slid along the guide rail 15 so as to cause engagement between guiding structures 38 of the guide rail 15 and slots 14 of the mounting device 1, thus from the position in FIG. 8B to the position in FIG. 8C. One or more visual indicators, e.g. transverse engravings, may be provided along the guide rail 15 to indicate suitable positions and/or ranges of positions for positioning the mounting devices 1 to a user.

Once the mounting device 1 reaches a desired position along the guide rail 15, it may be fastened in position e.g. by a fastening means, e.g. a threaded fastening bolt 40 as shown in FIG. 22, which extends through the through hole 11 of the mounting device 1 and engages a respective counter fastening means, in this example a square nut 39 (see FIG. 8C) which is positionable on a reverse side of the guide rail 15 with respect to the mounting device 1.

Thus, an exemplary mounting system comprises: two mounting devices 1; the bicycle accessory 2, wherein the mounting devices 1 are attached, at least attachable, to the bicycle accessory 2 via their attachment structure 5; the bicycle rack 3 which is provided with at least one associated mounting plug 4; the securing pin 25; and the guide rail 15. Alternatively, a mounting system may comprise a different number of mounting devices and may or may not comprise any, some or all of the other mentioned components.

During use, to allow the bicycle accessory 2 to be mounted to the rack 3, the two mounting devices 1 are attached to the bicycle accessory 2 at respective positions which correspond to positions of respective mounting plugs 4 of the bicycle rack 3, in particular with a mutual distance which corresponds to a distance between mounting plugs 4. As one example, as explained herein with reference to FIGS. 8A-C, two mounting devices 2 may be adjustably coupled to a same guide rail 15, in particular mutually spaced apart along the guide rail 15.

With reference to FIGS. 2 and 14 to 19, the mounting system may further comprise a support device 17. Best seen in FIGS. 14 to 17, the support device 17 comprises a respective attachment structure 18 configured for attaching the support device 18 to the bicycle accessory 2 independently from the mounting devices 1. The support device 17 further comprises at least one, in this example three, support structures 19, for pivotably supporting the support device 17, and with that the bicycle accessory 2, on the further mounting plug 4* of the bicycle rack 3.

The support structures 19 are here configured to engage a recess such as a locking recess 9 of the further mounting plug 4*, so as to prevent that the support device 17 and the further mounting plug 4* move away from each other when the support device 17 is supported on the further mounting plug 4*. To that end, the shown support structures 19 comprise a hook structure which is configured to extend into the locking recess 9 when the support device 17 is supported on the further mounting plug 4*, as shown in FIG. 15. It can be seen that alternatively or additionally, the further mounting plug 4* may be considered as comprising a hook structure which is configured to extend into a recess formed in the support structure 19. Thus, in other words, the support structure 19 and the further mounting plug 4* are configured to be hooked into each other to engage in a coupling which is pivotably about a substantially horizontal pivoting axis. The pivoting thereof is essentially stabilized when the mounting devices 1 are locked onto the mounting plugs 4.

In case a plurality of support structures 19 is provided as shown, the support structure or structures which are not in use for cooperation with the further mounting plug 4* may be closed off, for example by a respective closing element 31 of which an example is shown in FIG. 16. FIG. 17 shows two such closing elements 31 being positioned in two of the three support structures 19, leaving a central one of the support structures 19 available for cooperation with the further mounting plug 4*, i.e. as shown in FIGS. 14 and 15. The closing element 31 may for example be made from a resilient material to allow a clamping fit into a support structure 19. As shown, the closing element is preferably shaped to closely fit such a support structure 19.

The mounting system may further comprise a common handle 20 which is coupled, at least couplable, to respective operating elements 10 of the mounting devices 1 so as to enable single-handed simultaneous movement of the locking elements 8 of the mounting devices 1 to their releasing positions by a lifting movement of the common handle 20. Such a common handle 20 is shown i.a. in FIGS. 2 and 22. Here, the common handle 20 is in the form of, and may be used as, a general carrying handle for the bicycle accessory 2, so that a user can essentially release a mounted bicycle accessory 2 from the rack 3 by lifting and/or tilting the bicycle accessory 2 by said common handle 20. To provide the coupling between the common handle 20 and the operating elements 10, FIG. 22 shows as an example a loop or strap of the common handle 20 extending through an opening in the operating element 10. As one possible alternative, the common handle 20 could be provided with a cable or the like with a hooking element, e.g. a bead, at its end, wherein the hooking element engages a suitable hooking structure, e.g. with a constriction through which the cable but not the bead can extend, of the operating element 10.

The mounting devices 1 may be attached to the bicycle accessory 2 in various ways, at various positions and in various orientations, as can be seen by comparing FIGS. 2, 6, 7 and 21, for example. This includes optional direct attachment of a mounting device 1 to the accessory 2, as shown in FIG. 6. Thus, a highly versatile mounting solution can be provided.

Preferably, as shown in FIGS. 9 and 10, the bicycle accessory 2 comprises a plurality of respective attachment structures 21, here threaded holes, configured for direct and/or indirect attachment of: at least one mounting device 1; a support device 17; and/or a guide rail 15 thereto, e.g. using threaded bolts 40 as shown in FIG. 2. In particular, such system components may thus be selectively attached at one or more of a plurality of predefined positions and/or selectively in one or more of a plurality of predefined orientations with respect to the bicycle accessory 2. In this way, two or more positions of mounting plugs 4, 4* of the bicycle rack 3 can be matched. Additionally or alternatively, a mounted position and/or orientation of the bicycle accessory 2 with respect to the bicycle rack 3 can thereby be selected or defined, e.g. by a user.

In particular, as indicated in FIG. 9, in this example three different options A, B, C are provided for mounting the guide rail 15. Depending on the selected option, the guide rail 15 extends at a different angle with respect to the bicycle accessory 2, so that, in dependence of positions of the mounting plugs 4, a desired mounted orientation of the bicycle accessory 2 may be selected by selecting a corresponding one of the options A, B, C. For example, FIG. 2 shows the guide rail 15 attached according to option B, while FIGS. 18-22 show the guide rail 15 attached according to option A.

Returning to FIGS. 9 and 10, the attachment structures 21 of the bicycle accessory 2 can advantageously be arranged in a reinforcement structure 22 of the bicycle accessory 2, the reinforcement structure 22 preferably being fixedly or releasably arranged on an outer side of the bicycle accessory 2, for example on an outer back side thereof as shown. Thus, the at least one mounting device 1, support device 17 and/or guide rail 15 may be attached to such a reinforcement structure 22. With reference to FIG. 27A, to facilitate proper positioning of such elements before and during the attaching, the reinforcement structure 22 may be provided with one or more mounting guides 51, here small slits, configured to cooperate with corresponding followers (not shown), e.g. small cams, on the element to be positioned, here being the support device 17. It shall be appreciated that alternatively or additionally one or more guides may be provided in the element to be positioned, wherein one or more corresponding followers can then be arranged on the reinforcement structure 22.

In the shown example, the reinforcement structure 22 is advantageously arranged in a corresponding recess which is formed between sections of padding 42 which are provided on an outer back side of the bicycle accessory 2, the padding 42 promoting user comfort when the bicycle accessory 2 is used as a back pack or the-like. Here the reinforcement structure 22 and the corresponding recess are substantially T-shaped or rotated-H-shaped, having a relatively narrow central section 50 which during normal use extends downward from a relatively wide top section, preferably ending at a bottom section which is again wider than the narrow central section although possibly less wide than the top section.

FIGS. 27A-B show a variation in which the narrow central section 50 has a larger thickness than the top section and bottom section of the reinforcement structure 22. Thereby, stiffness such as torsional and/or bending stiffness can be additionally increased while the central section 50 can still remain relatively narrow so as to still expose the padding 42. Such an increased stiffness can facilitate easier mounting of the bicycle accessory 7, in particular when the accessory contains a relatively heavy load.

The exemplary reinforcement structure 22 is shown in FIG. 11 from a reverse side compared to the view of FIG. 9. It can be seen in FIG. 11 that the reinforcement structure 22 here comprises a reinforcement plate with a multitude of ribs. The reinforcement structure 22 can thereby impose a relatively stiff connection between the attachment structures 21 of the bicycle accessory 2 so as to enable said attachment structures 21 to have relatively stable positions with respect to each other, which ultimately aids in easy and stable mounting of the bicycle accessory 2 to the rack 3.

FIGS. 10 and 11 also show the reinforcement structure 22 as comprising threaded fastening portions 28 at its reverse side, i.e. a side facing inward with respect to the bicycle accessory 2. Such fastening portions 28 may facilitate fastening of the reinforcement structure 22 to one or more other structures of the bicycle accessory 2, for example to a structure to be reinforced, which may be made from a relatively soft material such as a textile or cloth material from which a bag can generally be made. As shown in FIG. 12, such fastening may involve engaging a respective fastening nut 29 with each fastening portion 28, for example from an inside of the bicycle accessory 2. Optionally, as shown in FIG. 13, a respective cap or the-like can be arranged to cover and protect the fastening nut 29 or other fastening means, as well as to provide a smooth surface on the inside of the bicycle accessory 2. Preferably, one or more water resistant seals are provided, in particular where the reinforcement structure 22, for example the fastening portions 28, may penetrate an otherwise water resistant portion of the bicycle accessory 2, so as to restore and/or enhance a resistance of the bicycle accessory 2 against ingress of e.g. rain water.

While such a reinforcement structure 22 can often be advantageous, in particular in case of bicycle accessory 2 which is otherwise relatively soft or compliant such as a bag, the mounting devices 1 and/or the guide rail 15 may in some alternative cases be attached to the bicycle accessory 2 without use of such reinforcement structure, as schematically illustrated in FIGS. 6 and 7. In that case, the mounting devices 1 and/or the guide rail 15, and optionally the support device 17, may for example be screwed and/or glued to a suitable other structure of the bicycle accessory 2. One or more water resistant seals may then be applied at such other structure to restore and/or enhance water resistance of the bicycle accessory 2.

With particular reference to FIGS. 18 and 19, an exemplary method of releasably mounting a bicycle accessory 2 to a bicycle rack 3 which is provided with mounting plugs 4 comprises: attaching two mounting devices 1 to the bicycle accessory 2 using their respective attachment structures 5; and causing the mounting plugs 4 to be received in the sockets 6 of the mounting devices 1, wherein the mounting plugs 4 are releasably locked in the sockets 6 using the respective locking mechanisms 7.

Prior to causing the mounting plugs 4 to be received in the sockets 6, the support device 17 may be attached to the bicycle accessory 2, and the attached support device 17 with the bicycle accessory 2 may be pivotably supported on a further mounting plug 4* of the bicycle rack 3. Causing the mounting plugs 4 to be received in the sockets 6 then preferably comprises pivoting the bicycle accessory 2 with respect to the bicycle rack 3, in particular about a pivoting axis associated with the pivotable supporting.

FIG. 18 shows such a bicycle accessory 2 about to be mounted to such a bicycle rack 3. First, a user may pivotably position the support device 17 on the further mounting plug 4*, as indicated by arrow I. Subsequently, while the support device 17 is thus supported on the further mounting plug 4*, the user may pivot the bicycle accessory 2 towards the rack 3 to engage the two mounting devices 1 with respective mounting plugs 4, as indicated by arrow II. By thus first pivotably supporting the bicycle accessory 2 on the rack 3, engagement of the mounting devices 1 with the mounting plugs 4 is made considerably easier compared to when such initial supporting would be omitted.

As can be understood from FIG. 4, the resulting insertion of the mounting plugs 4 into the sockets 6 of the mounting devices 1 then causes the locking elements 8 to be pushed upwardly against the biasing springs 27, thereby allowing the plugs 4 to move further into the sockets 6 until the locking elements 8 latch down into locking recesses 9, thereby releasably locking the plugs 4 in the sockets 6. The bicycle accessory 2 is thereby releasably mounted to the bicycle rack 3, as shown in FIG. 19.

As an optional further step, illustrated in FIGS. 20 to 22, a user may secure the mounted bicycle accessory 2 to the bicycle rack 3 by inserting a securing pin 25 through both mounting devices 1, in particular through eyes 24 of securing elements 23. The securing pin 25 may comprise a handle 33 at one end thereof, the handle 33 having a thickness that prevents it from moving through the mounting devices 1. At the other end, as can be seen in FIG. 22, the securing pin 25 may have a through hole 34 which allows e.g. a key-operated or code-operated padlock 32 to be connected thereto, so as to secure the securing pin 25 in place.

FIGS. 23 and 24 show that, when the securing pin 25 is not used to secure the bicycle accessory 2 to the rack 3, the securing pin 25 may conveniently be stored along the mounting devices 1 by snapping the pin 25 into engagement with holding elements 26 which may be provided at a top side of the mounting device 1. The holding elements 26 can also be seen in FIGS. 3 to 5. In this way, the securing pin 25 can conveniently be kept within reach for a user, so that the bicycle accessory 2 can easily be secured if and when desired.

To release the bicycle accessory 2 from the rack 3, if the securing pin 25 has been applied, a user first removes the securing pin 25 from its securing position, for example then storing the pin 25 in a storage position at the holding elements 26. With the optional securing pin 25 removed, the user may simply lift the handle 20 which is coupled to the operating elements 10 of the mounting devices 1. This lifting causes the locking elements 8 to move to their releasing positions, so that the user can then, essentially in one combined motion, easily and quickly carry the bicycle accessory 2 away from the rack 3, in particular by first tilting and then lifting the bicycle accessory 2, thus essentially an opposite trajectory from the mounting movements I and II indicated in FIG. 18. Thus, a particularly versatile, affordable and easy to use mounting solution is provided.

While the invention has been explained herein using exemplary embodiments and drawings, these do not limit the scope of the invention as defined by the appended claims. For the purpose of clarity and a concise description features are described herein as part of the same or separate embodiments, however, it will be appreciated that the scope of the invention may include embodiments having combinations of all or some of the features described falling within the scope of the following claims. Many variations and extensions, falling within the scope of the invention defined by the following claims, are possible, as will be understood by the skilled person. For example, less or more than two mounting devices may be used to mount a bicycle accessory to a bicycle rack. Further examples have been provided throughout the description.

### LIST OF REFERENCE SIGNS

1. Mounting device
2. Bicycle accessory
3. Bicycle rack
4. Mounting plug
4*. Further mounting plug
5. Attachment structure of mounting device
6. Socket
7. Locking mechanism
8. Locking element
9. Locking recess
10. Operating element
11. Through hole of mounting device
12. One end of through hole of mounting device
13. Other end of through hole of mounting device
14. Slot
15. Guide rail
16. Outer face of mounting device
17. Support device
18. Attachment structure of support device
19. Support structure of support device
20. Common handle
21. Attachment structure of bicycle accessory
22. Reinforcement structure
23. Securing element
24. Eye
25. Securing pin
26. Holding element
27. Biasing spring
28. Fastening portion of reinforcement structure
29. Fastening nut
30. Cap
31. Closing element
32. Padlock
33. Handle of securing pin
34. Through hole in securing pin
35. Abutment face of locking recess
36. Attachment structure of guide rail
37. Entry section of guide rail
38. Guiding structure of guide rail
39. Square nut
40. Fastening bolt
41. Entrance opening of socket
42. Padding
43. Intermediate connecting device
44. Connecting clamp
44a. Outer part of connecting clamp
44b. Inner part of connecting clamp
45. Frame of intermediate connecting device
45a. Primary mounting plug position of intermediate connecting device
45b. Secondary mounting plug position of intermediate connecting device
45c. Slit of intermediate connecting device
46. Adaptor element for mounting plug
47. Concave end of mounting plug
48. Concave end of adaptor element
49. Convex end of adaptor element
50. Central section of reinforcement structure
51. Mounting guide for support device
RD. Receiving direction
S. Standard distance

1. A mounting device for releasably mounting a bicycle accessory to a bicycle rack which is provided with a mounting plug, the mounting device comprising:
an attachment structure configured for attaching the mounting device to the bicycle accessory;
a socket configured for receiving the mounting plug of the bicycle rack therein; and
a locking mechanism for releasably locking the mounting plug in the socket when the mounting plug is received in the socket.

2. The mounting device according to claim 1, wherein the locking mechanism comprises a locking element which is movable between a locking position and a releasing position, wherein in the locking position the locking element extends into the socket, wherein in the releasing position the locking element extends less or not into the socket.

3. The mounting device according to claim 2, wherein in the locking position, when the mounting plug is received in the socket, the locking element extends into engagement with the mounting plug.

4. The mounting device according to claim 2, wherein the locking element is biased towards the locking position.

5. The mounting device according to claim 2, wherein the locking mechanism comprises an operating element coupled to the locking element and configured for moving the locking element between the locking position and the releasing position from outside the socket.

6. The mounting device according to claim 2, wherein the locking mechanism comprises at least one securing element coupled to the locking element and configured for selectively securing the locking element in the locking position.

7. The mounting device according to claim 6, wherein the at least one securing element comprises at least one eye through which a securing pin can be extended so as to inhibit the locking element from reaching the releasing position.

8. The mounting device according to claim 1, wherein the attachment structure comprises a through hole which, at one end thereof, opens towards the bicycle accessory during use, and which is configured for receiving a fastening means therethrough so as to allow the received fastening means to be fastened to the bicycle accessory for thereby attaching the mounting device to the bicycle accessory.

9. The mounting device according to claim 8, wherein the through hole opens into the socket at another end thereof.

10. The mounting device according to claim 1, wherein the attachment structure comprises at least one slot which is configured for slideably receiving a guide rail therein, which guide rail is attachable to the bicycle accessory so as to allow attachment of the mounting device to the bicycle accessory via the guide rail.

11. The mounting device according to claim 10, wherein the at least one slot is provided along an outer face of the mounting device, which outer face faces away from an entrance of the socket.

12. Mounting system comprising at least one mounting device according to claim 1 and at least one of:
the bicycle accessory, wherein the mounting device is attached, at least attachable, to the bicycle accessory via the attachment structure;
the bicycle rack which is provided with the at least one associated mounting plug;
another bicycle part which is provided with a mounting plug;
a securing pin extendable through an eye of the locking mechanism;
the guide rail attachable to the bicycle accessory and receivable in a slot of the attachment structure;
a support device which comprises a respective attachment structure configured for attaching the support device to the bicycle accessory independently from the at least one mounting device and at least one support structure for pivotably supporting the support device on a further mounting plug of the bicycle rack.

13. Mounting system according to claim 12, wherein the number of mounting devices is at least two.

14. Mounting system according to claim 13, wherein the at least two mounting devices are attached to the bicycle accessory at respective positions which correspond to positions of respective mounting plugs of the bicycle rack.

15. Mounting system according to claim 13 wherein the locking mechanism comprises a locking element and an operating element coupled to the locking element and configured for moving the locking element between a locking position and a releasing position, further comprising a common handle which is coupled, at least couplable, to respective operating elements of the mounting devices so as to enable single-handed simultaneous movement of the locking elements of the mounting devices to their releasing positions by movement of the common handle.

16. Mounting system according claim 12, wherein the bicycle accessory comprises a plurality of respective attachment structures configured for attachment of at least one mounting device and/or a support device and/or a guide rail thereto, so as to match two or more positions of mounting plugs of the bicycle rack and/or so as to enable a definition of a mounted position of the bicycle accessory with respect to the bicycle rack.

17. Mounting system according to claim 16, wherein the attachment structures of the bicycle accessory are arranged in a reinforcement structure of the bicycle accessory, the reinforcement structure arranged on an outer side of the bicycle accessory.

18. (canceled)

19. Method of releasably mounting a bicycle accessory to a bicycle rack which is provided with a mounting plug, comprising:
attaching at least one mounting device according to claim 1 to the bicycle accessory using the attachment structure; and
causing the mounting plug to be received in the socket, wherein the mounting plug is releasably locked in the socket using the locking mechanism.

20. Method according to claim 19, further comprising, prior to causing the mounting plug to be received in the socket:
attaching to the bicycle accessory a support device which comprises a respective attachment structure configured for attaching the support device to the bicycle accessory independently from the at least one mounting device and at least one support structure for pivotably supporting the support device on a further mounting plug of the bicycle rack; and
pivotably supporting the attached support device, and thereby the bicycle accessory, on the further mounting plug of the bicycle rack,
wherein causing the mounting plug to be received in the socket comprises pivoting the bicycle accessory with respect to the bicycle rack.

21. Mounting system according to claim 17, wherein the reinforcement structure is fixedly or releasably arranged on an outer side of the bicycle accessory.
